(19) United States
(12) Patent Application Publication
(10) Pub. No.: US 2004/0051531 A1
(43) Pub. Date: Mar. 18, 2004

(54) Method and apparatus for obtaining electrical images of a borehole wall through nonconductive mud

(76) Inventors: Roland Chemali, Sugarland, TX (US); Peter J. Schoch, Fort Worth, TX (US); Michael Andrew Yuratich, Hamble (GB)

Correspondence Address: DECKER, JONES, MCMACKIN, MCCLANE, HALL &, BATES, P.C., BURNETT PLAZA 2000, 801 CHERRY STREET, UNIT #46, FORT WORTH, TX, 76102-6836, US

(21) Appl. No.: 10/244,340

(22) Filed: Sep. 16, 2002

(51) Int. Cl. G01V 3/18

(52) U.S. Cl. 324/367; 324/374

(57) ABSTRACT

A resistivity logging apparatus has an array of electrodes projecting from imaging pads. The electrodes penetrate nonconductive mud lining the borehole wall. Some of the electrodes are moveable in and out of the pad while others of the electrodes can be fixed. The electrodes, which are arranged in an array along a circumferential portion of the borehole wall, are able to make contact with the borehole wall. Sequencing electronics causes one electrode to be a source, another to be a measuring electrode, with the measurements of source electrode and measuring electrode moving along the array in order to log a circumferential portion of the borehole wall.

### FIELD OF THE INVENTION

The present invention relates to electrically logging geological formations of a wall of a borehole penetrating earth formations.

### BACKGROUND OF THE INVENTION

Oil and gas wells are drilled with drilling mud. The use of mud during drilling provides many advantages. Mud is used to move cuttings from the drill bit uphole to the surface, thereby clearing the hole for the drill string. Circulating mud past the drill bit also serves to cool the rotating bit. In addition, the column of mud in the borehole provides counterpressure to the formation fluids, lessening the risk of a blowout during drilling.

One common type of drilling mud is water-based. Water-based muds are readily obtained and relatively inexpensive to use. In addition, water-based muds are conductive, a physical feature that is conducive to electrical logging.

Electrical logging tools use a number of electrodes in electrical contact with the borehole wall. An electrical signal is provided at an electrode for flow into the formation. The signal in the formation is then sensed by other electrodes, by way of voltage or other measurements. The effect of the formation on the signal leads to a determination of resistivity, which in turn leads to identifying the formation as containing hydrocarbons, porosity, etc.

In addition to water-based drilling muds, there are also oil-based drilling muds which are used for their enhanced performance. Unfortunately, oil-based drilling muds are not conductive; the mud forms a nonconductive layer on the borehole wall. Electrical imaging or logging tools do not operate well with such muds.

In the prior art, the assignee of the present invention utilizes a sensor pad known as a dual scratcher. One or more of the pads are forced radially outward from the main body of the logging tool. Each of the pads have a pair of spaced apart fixed electrodes. Each electrode is of a scratcher type and extends out from the surface of the pad. The electrodes are designed to penetrate the mud cake that coats the borehole wall. The use of two electrodes provides limited resolution in logging.

Another prior art tool is shown in U.S. Pat. No. 6,191,588. The tool has several imaging pads, with each pad having spaced apart current electrodes and button sensors located between the current electrodes. The button sensors measure voltage. This device has a depth of investigation that may be too large for accurately reflecting the geometries of geological features in the borehole walls. The tool more particularly measures the voltage differences between button sensors. As such, the tool behaves in a similar manner to a lateral device. Lateral devices show unwanted shadow effects at boundary crossings, making interpretations difficult. The smooth pad face prevents the sensors from making intimate or at least reliable contact with the conductive water that lays in the formation behind the oil based mud coating the borehole wall.

Therefore, what is needed is a tool that provides resistivity imaging of borehole walls through nonconductive muds.

### SUMMARY OF THE INVENTION

It is an object of the present invention to provide a method and apparatus for obtaining resistivity images of a borehole wall through nonconductive mud.

The apparatus of the present invention is for use in a borehole investigating tool that is moveable through the borehole. The apparatus comprises a pad having an outer surface and is structured and arranged so that the outer surface is to be pressed against a wall of the borehole. The apparatus has an array of at least three electrodes protruding from the pad outer surface. Each of the electrodes is an electrode structured and arranged to penetrate mud. The electrodes are electrically insulated from each other. At least one of the electrodes is resiliently mounted to the pad so that the distance the resiliently mounted electrode protrudes from the outer surface can vary.

In accordance with one aspect of the present invention, the resiliently mounted electrode is spring biased.

In accordance with another aspect of the present invention, the resiliently mounted electrode is located between the other electrodes, with two of the other electrodes being fixed mounted to the pad.

In accordance with still another aspect, the pad is articulated with respect to the tool.

In accordance with still another aspect of the present invention, the electrodes are arranged in a line across a width of the pad so as to correspond to a portion of the circumference of the borehole wall.

In accordance with still another aspect of the present invention, the resiliently mounted electrode is spring biased. The resiliently mounted electrode is located between the other electrodes, with two of the other electrodes being fixed mounted to the pad. The electrodes are arranged in a line across a width of the pad so as to correspond with a portion of a circumference of the borehole wall.

In accordance with still another aspect of the present invention, the array of electrodes comprises at least four electrodes.

In accordance with still another aspect of the present invention, the electrodes each comprise a sharp edge.

In accordance with still another aspect of the present invention, the electrodes each comprise a point.

In accordance with another aspect of the present invention, the apparatus further comprises a current source and a receiver. A source multiplexer is connected to a first set of the electrodes and to the source. A receiver multiplexer is connected to a second set of the electrodes and to the receiver. A controller is connected to the source multiplexer and the receiver multiplexer. The controller causes the source multiplexer to connect the source to one of the electrodes in the first set, with the one electrode being a current electrode, and causes the receiver multiplexer to connect the receiver to another of the electrodes in the second set, the other of the electrodes being a measuring electrode. The controller causes the source multiplexer and the receiver multiplexer to change the source electrode in the first set and the measuring electrode in the second set of electrodes.

The present invention also provides a method of investigation a wall of a borehole that is coated with a nonconductive mud. The method provides a pad with an array of at least three electrodes. The pad is forced toward the borehole wall. The electrodes penetrate any mud that may coat the borehole wall. The borehole wall is contacted with all of the electrodes in the array.

In accordance with one aspect of the present invention, the step of providing a pad with an array of at least three electrodes further comprises providing the pad with an array of electrodes arranged in a span corresponding to a circumferential portion of the borehole wall.

In accordance with another aspect of the present invention, the step of contacting the borehole wall with all of the electrodes in the array further comprises allowing at least some of the electrodes to move so as to protrude more or less from the pad.

In accordance with another aspect of the present invention, two of the electrodes are fixed to the pad.

The present invention also provides a method of investigating a borehole wall that is coated with a nonconductive mud. An array of electrodes penetrates the mud so as to make contact with the borehole wall. A first current is supplied to a first one of the electrodes and a second voltage is measured with a second one of the electrodes so that a first apparent resistivity can be determined from the first current and the second voltage. A second current is supplied to another of the electrodes and a third voltage is measured with a third one of the electrodes, so that a second apparent resistivity can be determined from the second current and the third voltage.

In accordance with one aspect of the present invention, the step of supplying the second current to another electrode further comprises supplying the second current to the second electrode.

In accordance with another aspect of the present invention, the mud is penetrated with an array of electrodes that extends along a portion of the circumference of the borehole wall, with the second electrode being between the first and third electrodes. The steps of providing a current to one electrode and measuring the voltage with another electrode is repeated along the array of electrodes.

In accordance with another aspect of the present invention, the step of penetrating the mud with an array of at least three electrodes further comprises the step of allowing at least one of the electrodes to move so as to penetrate various thicknesses of mud.

### BRIEF DESCRIPTION OF THE DRAWINGS

FIG. 1 is a schematic view of a borehole, showing the logging tool of the present invention, in accordance with a preferred embodiment.

FIG. 2A is a front view of a portion of an imaging pad showing an electrode array. FIGS. 2B and 2C are schematic front views showing portions of imaging pads with alternate electrode arrays.

FIG. 3 is a detailed front view of an electrode.

FIG. 4 is a detailed side view of an electrode.

FIG. 5A is a cross-sectional view of a moveable electrode mounted in the pad, taken along lines V-V of FIG. 2A.

FIG. 5B is a cross-sectional side view of a moveable electrode, in accordance with another embodiment.

FIG. 5C is a cross-sectional view of a moveable electrode mounted in the imaging pad, in accordance with another embodiment.

FIG. 5D is a side view of the electrode of FIG. 5C.

FIG. 6 is a block diagram showing the electronics to energize the electrodes with current and measure the voltage with the electrodes.

FIGS. 7A-7D are schematic top cross-sectional views showing the pad and its associated electrodes in contact with various borehole wall configurations and muds.

FIGS. 8A and 8B are schematic top views showing the imaging pad on its mounting arrangement and its associated electrodes in contact with the borehole wall in various configurations.

### DESCRIPTION OF THE PREFERRED EMBODIMENT

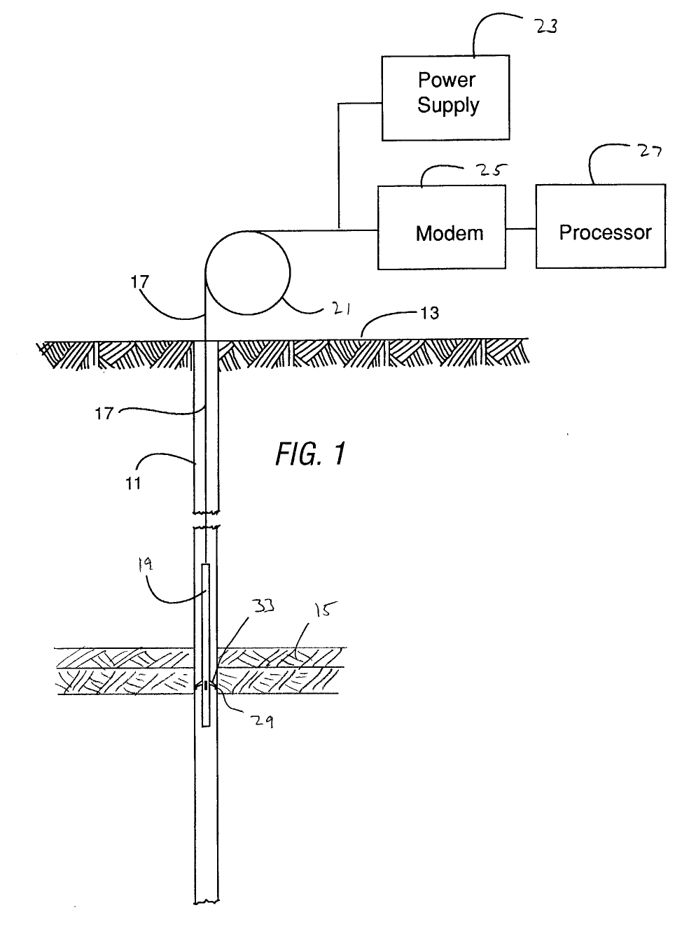

In FIG. 1, there is shown a borehole 11 penetrating the earth 13 extending down into various formations 15. The borehole 11 is uncased. Suspended in the borehole 11 by a wireline 17 is the tool 19 of the present invention, in accordance with a preferred embodiment. The tool 19 acquires information on the formations 15 surrounding the borehole, which information is used to evaluate formations for hydrocarbon content and extractability, as well as for electrically imaging the formation.

The tool 19 can log the formations through nonconductive drilling mud. Nonconductive drilling mud is known in the industry as oil-based mud (OBM). Oil-based mud is an emulsified drilling mud with oil as a continuous phase. An aqueous phase can make up a small part of the mud. Another type of nonconductive drilling mud is “synthetic” mud. Many synthetic muds are nonconductive.

The wireline 17 both suspends the tool 19 and provides power and data transmission capabilities. The wireline 17 extends to the surface to a drum 21 which raises and lowers the tool 19 in the borehole. The conductors inside of the wireline are connected to a power supply 23 which provides the electrical power necessary to operate the various components of the tool 19. In addition, the wireline 17 connects to a surface modem 25 for communication with the downhole tool stack 19. A surface processor 27 is connected to the modem 25, which processor processes the measured data. In addition, the processor 27 sends commands down to the tool 19 to control logging.

The downhole tool 19 typically contains several tools and therefore forms a tool stack. For the description that follows, only the tool of interest, a resistivity tool, will be described. The resistivity tool 19 has a number of pads 29, with each pad having electrodes 31 (see FIG. 2A) thereon. A current is passed out of one of the electrodes, while the potential difference, or voltage, is measured with one of the other electrodes.

The present invention utilizes sharp or pointed electrodes 31 (see FIGS. 2A, 3 and 5A). The electrodes 31 penetrate the drilling mud that may be caked on, or lining, the borehole wall and thus make good electrical contact with the formations 15.

In addition, the present invention provides an array of electrodes so that resistivity can be measured across circumferential portions of the borehole wall, enabling the generation of images of the borehole wall.

Borehole walls are typically populated with irregularities and varying curvatures due to drilling operations. In addition, the thickness of the nonconductive mud may vary. The present invention is able to compensate for such irregularities or mismatches in curvature between the tool pads and the borehole wall, as well as variations in mud thickness, so as to ensure electrical contact between all of the electrodes in the array and the borehole wall.

The tool 19 has a number of pads 29 (FIG. 1) spaced circumferentially from each other. Each pad is mounted on the end of an arm 33. The arm 33 allows the pad to move between a stowed position, wherein the pad is in close proximity to the tool body, to a deployed position, wherein the pad is radially extended outward so as to contact the wall of the borehole 11. The arms 33 are either spring-loaded or motor-actuated so as to push the pads into contact with the borehole wall. In the preferred embodiment, each tool 19 has four to six pads 29 spaced evenly apart circumferentially.

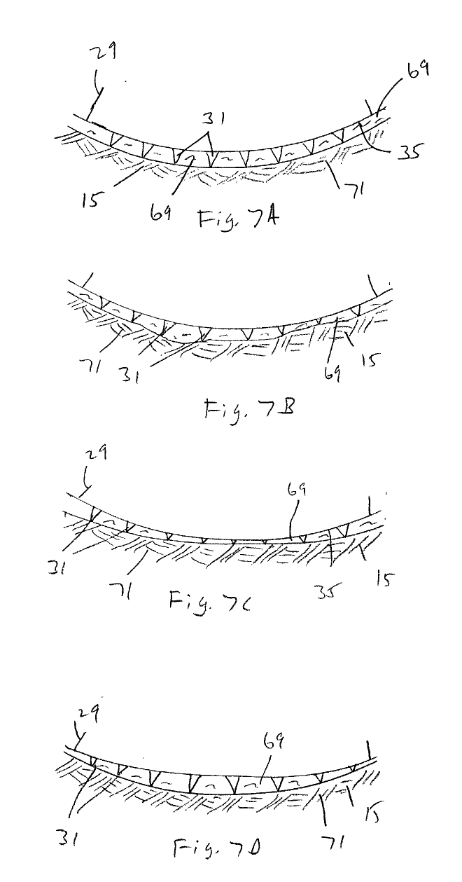

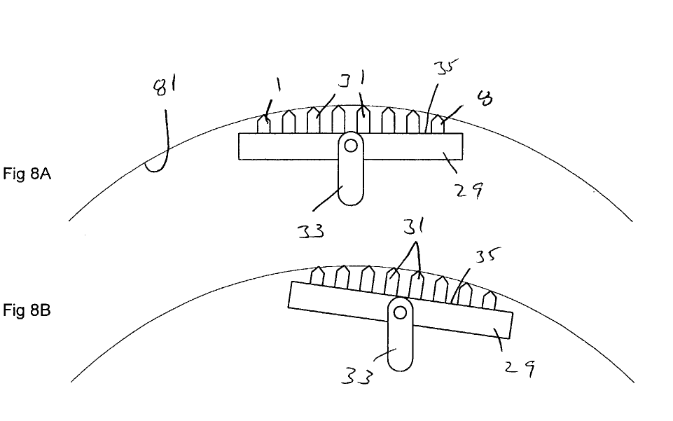

The outer surface 35 (FIGS. 2A, 7A) of each pad 29 can be curved so as to approximate the curvature of the borehole wall. Alternatively, the outer surface 35 can be flat (see for example, FIGS. 8A and 8B). The tools and the pads are sized according to the borehole size. Smaller diameter boreholes require pads with more curvature on the outer surface than do larger diameter boreholes. Each pad 29 is swivel-mounted to a respective arm 33 so as to partially rotate about an axis that is parallel to the longitudinal axis of the tool 19.

Each pad 29 has an array of electrodes 31. The array comprises at least three electrodes, although in the preferred embodiment, the array is four or more electrodes. In the preferred embodiment, the electrodes 31 are arranged linearly (see FIG. 2A) across a portion of the width of the pad so as to measure a portion of the circumference of the borehole wall. For reference herein, the electrodes 31 are numbered 1-8, with electrodes 1 and 8 being the endmost electrodes. FIGS. 2B and 2C show representative nonlinear electrode arrays in which four electrodes are on two rows displaced from one another. FIG. 2B shows the electrodes 2, 4, 6 and 8 of the top row vertically staggered with respect to the electrodes 1, 3, 5 and 7 of the bottom row. FIG. 2C shows the electrodes 2, 4, 6 and 8 vertically aligned with respect to the electrodes 1, 3, 5 and 7 of the bottom row. Measurements are made between inter-row and intra-row electrodes. Multi-row arrays having more than two rows of electrodes can be utilized.

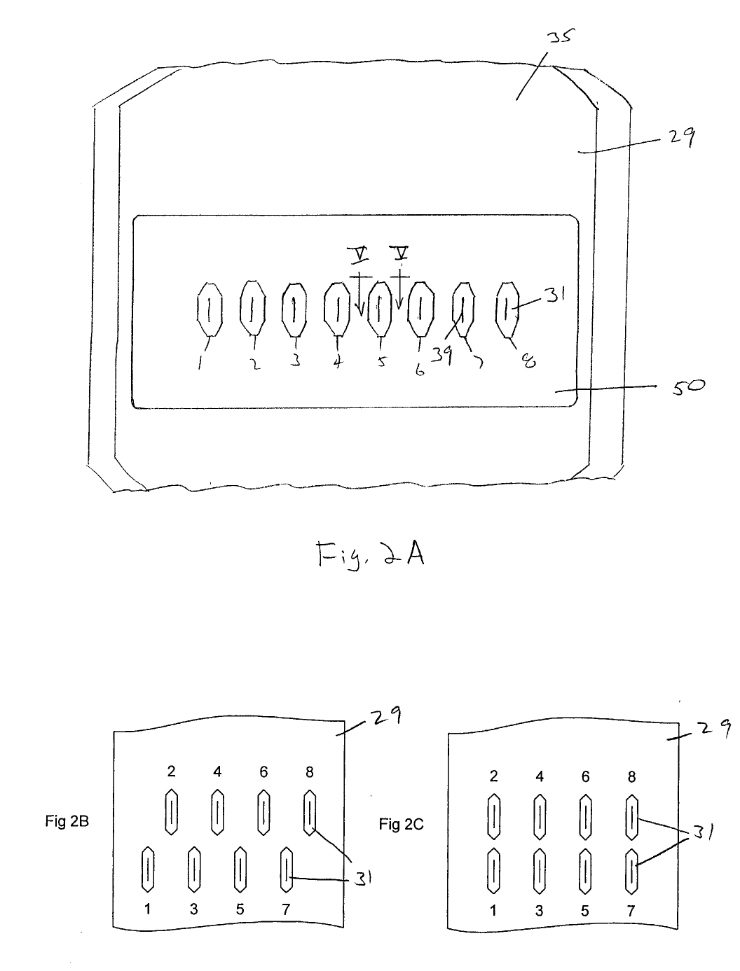

Referring to FIGS. 3 and 4, the electrodes 31 are configured to penetrate a layer or cake of mud lining the borehole wall. Each electrode 31, which is conductive, has a base 37 mounted in the pad. The electrode 31 extends out from the base 37, tapering to an edge 39. The edge 39 need not be knife sharp and can be dulled to prevent injury to an operator handling the tool. The edge can penetrate mud however. The edge 39 is oriented so as to be parallel with the direction the pad is to travel within the borehole wall. As shown in FIG. 4, the edge 39 can be flat, or it can be curved outwardly, or crowned, so as to bulge out in the center. The electrodes are known as “scratchers”.

The pad 29 has moveable electrodes, which are electrodes that move in and out of the pad. Thus, with a moveable electrode, the distance the electrode protrudes from the pad outer surface 35 can vary. The electrodes are moveable so as to compensate for the tilting of the tool away from the borehole axis, in addition to accommodating tool eccentricity and borehole irregularity. All of the electrodes 31 can be moveable. Alternatively, two of the electrodes can be fixed to the pad, wherein the distance the electrodes protrudes from the outer surface of the pad is fixed. In the preferred embodiment, the two endmost electrodes 1, 8 (see FIG. 2A) are fixed to the pad. This ensures that the pad has at least two contact points with the borehole wall, which borehole wall will not collapse into the pad under pressure of contact, thereby providing a pad stand-off for the remaining electrodes. The intermediate electrodes 2-7 (see FIG. 2A) between the endmost electrodes are moveable with respect to the pad outer surface 35. Thus, the individual intermediate electrodes can move in and out relative to the pad. As an alternative, two electrodes other than the endmost electrodes 1, 8 can be fixed to the pad. In the multi-row embodiments of FIGS. 2B and 2C, electrodes 1 and 7 are fixed while the others are moveable.

Each electrode 31 is received by a cavity in the pad 29 so that the edge 39 protrudes out therefrom. Each electrode has a wire conductor 47 connected to the base. Fixed electrodes are secured in the cavity by a potting compound.

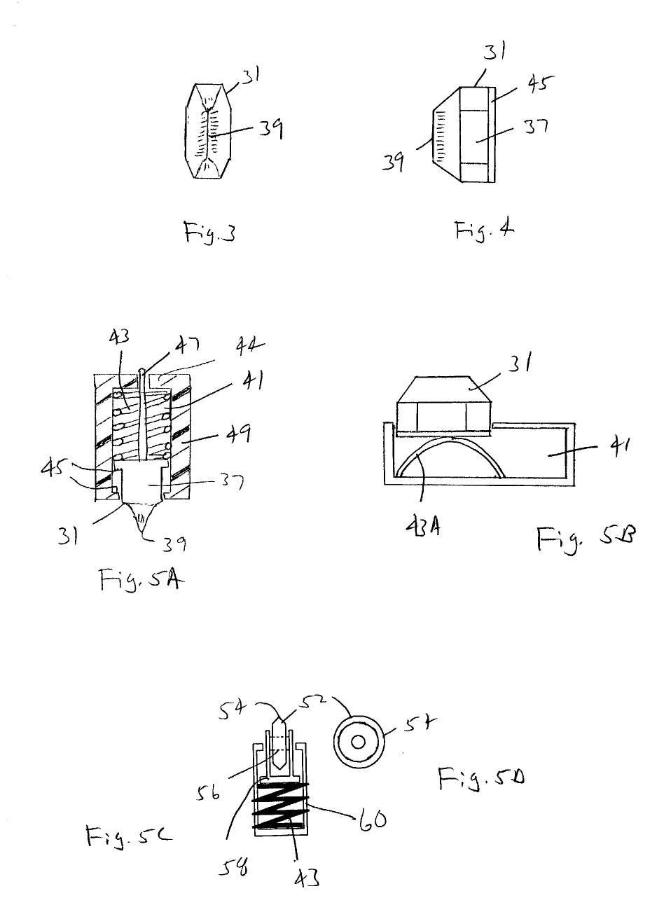

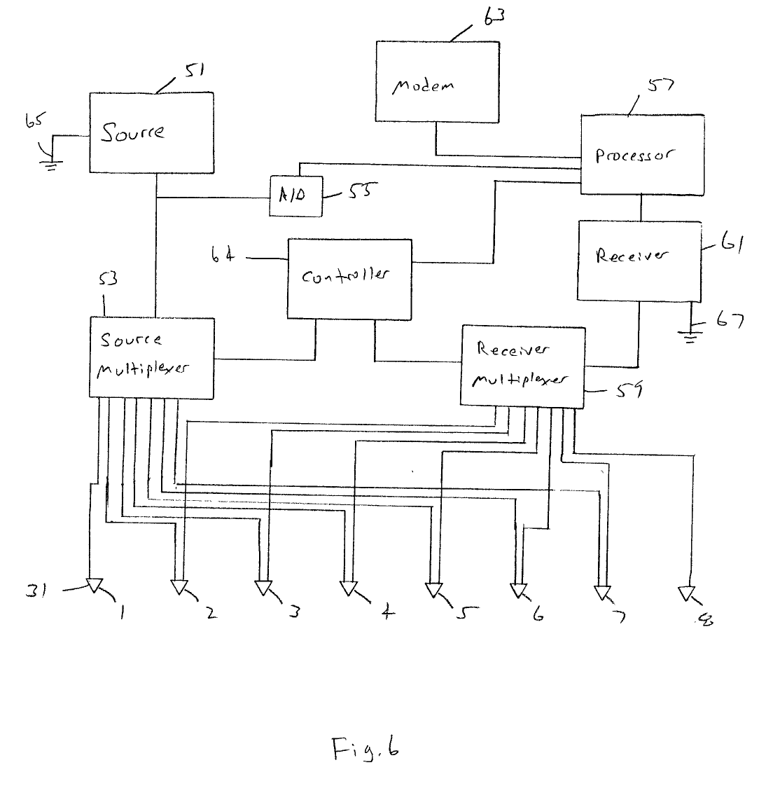

Referring to FIG. 5A, each moveable electrode is fitted so as to move within the cavity 41 in the pad. The base 37 of the electrode is received by the cavity 41 while the edge 39 and tapering portion extend out from the pad. A helical spring 43 is interposed between the base 39 and the back wall 44 of the cavity 41. The spring 43 biases the electrode 31 in the outward position. The electrode 31 can move in and out of the cavity 41. (In FIG. 5A, the electrode 31 is shown as pushed partly into the cavity 41.) The electrode and pad have corresponding stops 45 so that the spring is unable to push the electrode out of the cavity. A wire 47 extends from the base 37 to the back of the cavity.

The electrodes 31 are electrically insulated from one another and from ground. The pad 29 can be entirely made of an insulating material. Alternatively, the area around the electrodes can be made of an insulating material. In addition, the immediate space around the electrodes are insulated; the fixed electrodes are insulated by the potting compound and the moveable electrodes are insulated by a sleeve 49. The insulating sleeve lines the interior of the cavity 41. The electrode moves inside of this insulating sleeve. Alternatively, the sleeve can be mounted to the electrode so as to move therewith.

The electrodes 31 and their associated cavities are contained in a member 50 (see FIG. 2A) that is mounted to the pad 29. The member 50 is removable from the pad so as to allow the changing of the electrode array. The outer surface of the member 50 forms part of the outside surface 35 of the overall pad 29.

FIG. 5B shows an electrode 31 in accordance with another embodiment. Instead of a helical spring, a leaf-like spring 43A is used to resiliently bias the electrode 31 in the outward position. The spring 43A has good force over a long extension.

An alternate electrode that is subject to less friction when in contact with the borehole wall is shown in FIGS. 5C and 5D and is known as a “pizza cutter”. The electrode 52 is a wheel with a sharp edge 54. The wheel is rotatably mounted to an axle 56, which in turn is mounted to a carrier 58. The axle 56 may be fixed to either the electrode or to the carrier. The carrier 58 is spring-mounted 43 inside of a sleeve 60. As the electrode is moved along the borehole wall, it penetrates the mud cake and rotates. Thus, the electrode 52 is rolled, not dragged, along the borehole wall. In the description, general reference to electrodes 31 also includes reference to electrodes 52.

The arms 33 resist the force of the individual electrode springs 43, 43A so as to force the pads 29 and their electrodes into contact with the borehole wall.

Still another electrode that can be utilized is shaped like a pencil; the electrode is pointed instead of having an edge. The electrode would appear from all four sides as shown in FIG. 5A. The pencil-like electrode can be used alone or in combination with the other types of electrodes 31, 52.

The scratcher electrode 31, “pizza-cutter” electrode 52 and pencil-like electrode can be used in any of the arrangements of FIGS. 2A, 2B and 2C.

The electrodes 31 are preferably used to conduct measurements in a manner similar to a normal electrode configuration, and specifically to a “short normal” configuration. In the industry, short normal has taken on the meaning of the electrodes (source (A) and measuring (M)) spaced 16 inches apart. Such spacing is typically measured in the direction corresponding to the length of the borehole. The electrodes 31 on the pad 29 of the present invention typically will not be 16 inches apart and are spaced closer together. It will be appreciated that other types of measurements, such as lateral measurements and multiple normal measurements known in the industry, may be made with the electrodes 31.

Some of the electrodes 31 serve as source electrodes, while others serve as measuring electrodes while still others serve as both source and measuring electrodes, although at different times. FIG. 6 illustrates the electronics associated with the electrodes 31. A source 51 provides a current. The source 51 can be located on the surface or on the tool 19. The source services all of the pads 29 on the tool. The source 51 is connected to a source multiplexer 53. The source multiplexer 53 is connected to those electrodes 31 which are intended to be operated as a source. The source multiplexer 53 is located either in the tool or in the pad 29. An A/D converter 55 provides a current measurement of the output of the source 51 to a processor 57. Those electrodes 31, which are intended to measure voltage, are connected to a receiver multiplexer 59, which receiver multiplexer is in turn connected to a signal receiver and conditioner 61. The receiver 61 has an A/D converter therein. The signal receiver 61 is connected to the processor 57. The processor 57 is in turn connected to a modem 63 for communication up to the surface on the wireline 17. Alternatively, the processor 57 can be connected to an intertool bus if the downhole tool contains several downhole tools. A controller 64 is connected to the source multiplexer 53, the receiver multiplexer 59 and to the processor 57. The receiver multiplexer 59, the receiver 61, the processor 57 and the controller 64 are located either on the pad or on the tool. The modem is typically located on the tool stack. As an alternative, the functions of the controller 64 can be performed by the processor 57.

The source 51 emits a current through one of the electrodes to a remote return 65. The return 65 can be the casing, the cable head, a surface electrode or an electrode on the same or a nearby pad 29. The receiver 61 measures the voltage across one of the electrodes (which electrode is not a source electrode at the time of measurement) and a remote reference location 67. The voltage reference 67 can be the casing, the cable head, a surface electrode or an electrode on the same or a nearby pad.

The operation of the tool 19 will now be described. The tool is prepared for logging in the borehole. The arms 33 extend the pads 29 radially outward (see FIG. 1). Referring to FIG. 7A, the electrodes 31 penetrate the mud lining 69 to contact the borehole wall 71. When the curvature of the pad 29 matches the curvature of the borehole wall 71 and the thickness of the mud is uniform, as shown in FIG. 7A, the distance between the pad and the borehole wall is uniform. Thus, the electrodes 31 all protrude at the same distance from the pad outer surface 35. FIG. 7B illustrates the condition when the mud lining 69 has a non-uniform thickness due to several irregularities in the borehole wall 71. The moveable electrodes move in and out the appropriate distance to make contact through the mud with the borehole wall. FIG. 7C illustrates where the curvature of the borehole wall 71 is much greater than the curvature of the pad 29. The endmost electrodes will protrude much further than the intermediate electrodes. FIG. 7D illustrates the opposite condition wherein the curvature of the borehole wall is smaller than the curvature of the pad due to drilling operations. The intermediate electrodes will extend much further than the endmost electrodes. The two endmost electrodes, which are fixed, contact the borehole wall through the mud. The intermediate electrodes are pushed into contact with the borehole wall by the springs 43.

FIGS. 8A-8B show a top view of the imaging pad 29 pivotally mounted to an arm 33 arrangement. In FIG. 8A, the imaging pad 39 is pressed against a circular borehole wall 81 with the arm carrying the pad on the centerline of the borehole. The fixed outer electrodes 1, 8 provide support and the intermediate electrodes move outwards to establish contact with the borehole wall.

FIG. 8B shows the imaging pad 29 when pressed against the same borehole wall, but with the arm 33 offset from the centerline of the borehole. Such an alignment occurs when the tool body is displaced in the borehole, a common occurrence. The imaging pad 29 is rotated about its mount on the arm 33 so as to be parallel to an imaginary line drawn between the tips of the fixed outer electrodes 1, 8. The intermediate electrodes move exactly as before.

In FIGS. 8A and 8B, the outer surface 35 of the pad is flat. This creates a gutter space between the pad and the mud wall for the mud scrapings to pass through.

During logging, the tool 19 is pulled up the borehole 11 with the electrodes 31 maintaining contact with the borehole wall 71. The electrodes cut their way through the mud 69 as the tool is being raised.

The source electrodes are energized with current in sequence, while the electrodes are enabled for measuring in a corresponding sequence. The controller 64 operates the multiplexers 53, 59 to sequence connecting the electrodes to the source 51 and receiver 61. For example, referring to FIG. 6, electrode 1 is the source for a period of time. The source multiplexer 53 connects electrode 1 to the source 51, wherein a current I1 is emitted by electrode 1 to the return 65. The receiver multiplexer 59 connects electrode 2 to the receiver 61, wherein electrode 2 measures the voltage V2 due to I1. Both the current I1 and the voltage V2 are sent to the processor 57, which determines an apparent resistivity by determining the ratio of V2/I1 and multiplying it by a geometrical coefficient. The measurement point is between the two electrodes 1, 8. The measurements of I1 and V2 last for a few milliseconds. Then, the source multiplexer 53 causes electrode 2 to be connected to the source 51, disconnecting electrode 1, and the receiver multiplexer 59 causes electrode 3 to measure voltage by being connected to the receiver 61, and also disconnecting electrode 2 from the receiver. Electrode 2 emits a current I2 and electrode 3 measures the voltage V3 due to current I2. An apparent resistivity is measured as described above. The measurements are sequenced from electrode to electrode along the array of electrodes until electrode 7 is the source, emitting current I7 and electrode 8 measures V8; after which the cycle is repeated beginning again at electrode 1. Thus, resistivity measurements are obtained across the array of electrodes.

Other measuring patterns can be used. For example, electrode 1 emits a current I1 and electrode 3 measures voltage V3. I1 and V3 are used to determine resistivity, with the measurement point at electrode 2, or between the electrodes 1 and 3. Next, electrode 2 emits a current I2 and electrode 4 measures voltage V4. The measurements are sequenced from electrode to electrode until electrode 6 is the source, emitting current I6 and electrode 8 measures V8, after which the cycle is repeated beginning at electrode 1.

For the electrode arrangements of FIGS. 2B and 2C, measuring points can be between electrodes 1-2, 2-3, 3-4, 4-5, 5-6, 6-7 and 7-8. Alternatively, measuring points can be between electrodes 1-3, 2-4, 3-5, 4-6, 5-7 and 6-8. As discussed above, to achieve a measuring point between, for example, electrodes 1-2, current I1 is provided to electrode 1 and the voltage V2 is measured at electrode 2.

The use of the array of electrodes enables resistivity data to be gathered in an azimuthal direction, or across a circumferential section of the borehole walls. If the pads are overlapping (but vertically staggered), then resistivity data can be acquired for the entire circumference of the borehole wall.

All of the apparent resistivity measurements are plotted as an image map versus depth and versus azimuth. These plots can then be interpreted to determine if the formations have any hydrocarbons and the extractability thereof.

Thus, with the present invention, an image of the borehole wall can be obtained even if the borehole wall is coated with a nonconductive mud. The pads and their arrays of electrodes are designed to penetrate the mud and maintain contact with the borehole wall of all of the electrodes. The moveable, flexible mounted electrodes compensate for irregularities or mismatches of curvature in the borehole wall.

Although the array of electrodes has been described as having two fixed electrodes, if the array is nonlinear (for example, FIGS. 2B and 2C), then three fixed electrodes could be used, wherein a “tripod” is formed by the fixed electrodes against the borehole wall. The pad 29 should be able to articulate relative to the arm 33 and about a horizontal axis, to ensure contact of the fixed electrodes against the borehole wall. The other electrodes could be moveable. Such a nonlinear array could have at least four electrodes. Also, as discussed above, the array need not have fixed electrodes, having instead all of the electrodes as moveable. The fixed electrodes provide the benefit that they define a fixed stand-off from the borehole wall, so that in conjunction with logging tool measurement of the arm openings, the precise position of each measurement on the tool relative to the others may be determined. This is useful for data interpretation.

The foregoing disclosure and showings made in the drawings are merely illustrative of the principles of this invention and are not to be interpreted in a limiting sense.

1. An apparatus for use in a borehole investigating tool that is moveable through the borehole, the apparatus comprising:
a) a pad having an outer surface and being structured and arranged so that the outer surface is to be pressed toward a wall of the borehole;
b) an array of at least three electrodes protruding from the pad outer surface, each of the electrodes being an electrode that is structured and arranged to penetrate mud, the electrodes being electrically insulated from each other;
c) at least one of the electrodes being resiliently mounted to the pad so that the distance the resiliently mounted electrode protrudes from the outer surface can vary.

2. The apparatus of claim 1 wherein the resiliently mounted electrode is spring-biased.

3. The apparatus of claim 1 wherein the resiliently mounted electrode is located between the other electrodes, with two of the other electrodes being fixed mounted to the pad.

4. The apparatus of claim 3 wherein the pad is articulated with respect to the tool.

5. The apparatus of claim 1 wherein the electrodes are arranged in a line across a width of the pad so as to correspond to a portion of a circumference of the borehole wall.

6. The apparatus of claim 1 wherein:
a) the resiliently mounted electrode is spring-biased;
b) the resiliently mounted electrode is located between the other electrodes, with two of the other electrodes being fixed mounted to the pads;
c) the electrodes are arranged in a line across a width of the pad so as to correspond to a portion of a circumference of the borehole wall.

7. The apparatus of claim 1 wherein the array of electrodes comprises at least four electrodes.

8. The apparatus of claim 1 wherein the electrodes comprise a sharp edge.

9. The apparatus of claim 1 wherein the electrodes comprise a point.

10. The apparatus of claim 1 further comprising:
a) a current source;
b) a source multiplexer connected to a first set of the electrodes and to the source;
c) a receiver;
d) a receiver multiplexer connected to a second set of the electrodes and to the receiver;
e) a controller connected to the source multiplexer and the receiver multiplexer, the controller causing the source multiplexer to connect the source to one of the electrodes in the first set, the one of the electrodes being a current electrode, and causing the receiver multiplexer to connect the receiver to another of the electrodes in the second set, the other of the electrodes being a measuring electrode, the controller causing the source multiplexer and the receiver multiplexer to change the source electrode in the first set and the measuring electrode in the second set of electrodes.

11. A method of investigating a wall of a borehole that is coated with a nonconductive mud, comprising the steps of:
a) providing a pad with an array of at least three electrodes;
b) forcing the pad toward the borehole wall;
c) penetrating with the electrodes any mud that may coat the borehole wall;
d) contacting the borehole wall with all of the electrodes of the array.

12. The method of claim 11 wherein the step of providing a pad with an array of at least three electrodes further comprises the step of providing the pad with an array of electrodes arranged in a span corresponding to a circumferential portion of the borehole wall.

13. The method of claim 11 wherein the step of contacting the borehole wall with all of the electrodes in the array further comprises allowing at least some of the electrodes to move so as to protrude more or less from the pad.

14. The method of claim 13 further comprising the step of fixing two of the electrodes to the pad.

15. A method of investigating a borehole wall that is coated with a nonconductive mud, comprising the steps of:
a) penetrating the mud with an array of at least three electrodes in contact with the borehole wall;
b) supplying a first current to a first one of the electrodes and measuring a second voltage with a second one of the electrodes and determining a first apparent resistivity from the first current and the second voltage;
c) supplying a second current to another of the electrodes and measuring a third voltage with a third one of the electrodes and determining an apparent resistivity from the second current and the third voltage.

16. The method of claim 15 wherein the step of supplying a second current to another electrode further comprises supplying the second current to the second electrode.

17. The method of claim 16, wherein:
a) the step of penetrating the mud with an array of electrodes further comprising the step of penetrating the mud with an array of electrodes that extend along a portion of the circumference of the borehole wall, with the second electrode being between the first and third electrode;
b) repeating the steps of providing a current to one electrode and measuring the voltage of another electrode along the array of electrodes.

18. The method of claim 15 wherein the step of penetrating the mud with an array of at least three electrodes further comprises the step of allowing at least one of the electrodes to move so as to penetrate various thicknesses of mud.
